(19) United States
(12) Patent Application Publication
(10) Pub. No.: US 2021/0087943 A1
(43) Pub. Date: Mar. 25, 2021

(54) FIVE CYLINDER PLUNGER PUMP

(71) Applicant: YANTAI JEREH PETROLEUM EQUIPMENT & TECHNOLOGIES CO., LTD., Yantai (CN)

(72) Inventors: Haiping Cui, Yantai (CN); Jixin Wang, Yantai (CN); Wenping Cui, Yantai (CN); Xiaosong Wei, Yantai (CN); Peng Li, Yantai (CN); Hailong Li, Yantai (CN)

(21) Appl. No.: 16/832,220

(22) Filed: Mar. 27, 2020

(30) Foreign Application Priority Data
Sep. 20, 2019 (CN) 201910893316.0

(51) Int. Cl. F01D 15/08; F04B 17/00; F16H 1/28

(52) U.S. Cl. CPC F01D 15/08; E21B 43/26; F16H 1/28; F04B 17/00

(57) ABSTRACT

The present invention discloses a five cylinder plunger pump, including a power end assembly, a hydraulic end assembly and a reduction gearbox assembly, one end of the power end assembly is connected to the hydraulic end assembly, the other end of the power end assembly is connected to the reduction gearbox assembly; the reduction gearbox assembly includes a planetary reduction gearbox and a parallel reduction gearbox which are used in conjunction with each other, with a transmission ratio of 60:1 to 106:1. Beneficial effects: the rated input power is increased to 5000-7000 hp, the stroke can be up to 10 to 12 inches, and the maximum input speed of the reduction gearbox assembly on the plunger pump is increased from the current 2100 rpm to 16000 rpm, the reduction gearbox assembly can be directly connected to the turbine engine to solve the problem that the turbine fracturing equipment is slown down through two reduction gearboxes, thus decreasing the weight of the vehicle and reducing the overall size of the equipment.

### TECHNICAL FIELD

The present invention relates to the technical field of plunger pumps, and specifically to a five cylinder plunger pump.

### BACKGROUND

With the continuous development of ultra-high pressure, ultra-deep wells and horizontal wells in oil and gas fields, their operating conditions are getting worse and worse, requiring operations with high pressure and large displacement. Therefore, the requirements on the plunger pump are getting higher and higher. A single fracturing equipment can output high pressure and large displacement, which requires that the plunger pump can output high power and high pressure. Especially for the unconventional oil and gas operations such as shale gas operations, the working conditions are harsh, which requires long time operation with large displacement and high pressure. And the higher frequency of operations indicates higher requirements on the fracturing equipment and also on the plunger pump, which is the core component of the fracturing equipment. Turbine fracturing equipment is driven by electric motors and powered by the turbine engines, the input power of which can be up to 5600 hp, and the input speed can be up to 16000 rpm. At present, the maximum power of plunger pump on the market reaches 7000 hp, but the maximum input speed is only around 2100 rpm. Generally, turbine fracturing equipment adopts a structure in which a turbine engine is used to output power, an output end of the turbine engine is connected to a high speed and heavy load reduction gearbox. The high speed and heavy load reduction gearbox is mainly used to slow down the high speed of the turbine engine to around 2100 rpm, meanwhile increase the output torque. An output end of the high speed and heavy load reduction gearbox is connected to a transmission shaft, and the other end of the transmission shaft is connected to the reduction gearbox on the plunger pump. The reduction gearbox on the plunger pump is mainly used to slow down the input speed from 2100 rpm to a few hundred revolutions, with the same function of slowdown and increasing torque. Therefore, two reduction gearboxes and one transmission shaft are needed for the entire turbine fracturing equipment, thus inevitably increasing the weight and overall size of the entire vehicle and affecting the layout thereof. Therefore, it is necessary to develop a super-high speed and super-high power plunger pump to match the turbine fracturing equipment.

### SUMMARY

To overcome the deficiencies in the prior art, an objective of the present invention is to provide a five cylinder plunger pump, its rated input power is increased to 5000-7000 hp, the stroke can be up to 10 to 12 inches, and the maximum input speed of the reduction gearbox assembly on the plunger pump is increased from the current 2100 rpm to 16000 rpm, thus meeting the reduction requirements from the turbine engine to the plunger pump. That is to say, the reduction gearbox can be directly connected to the turbine engine to solve the problem that the current turbine fracturing equipment is slown down through two reduction gearboxes, thus decreasing the weight of the vehicle and reducing the overall size of the equipment.

The objective of the present invention is achieved by the following technical measures: a five cylinder plunger pump, including a power end assembly, a hydraulic end assembly and a reduction gearbox assembly, one end of the power end assembly is connected to the hydraulic end assembly, the other end of the power end assembly is connected to the reduction gearbox assembly, the reduction gearbox assembly includes a planetary reduction gearbox and a parallel reduction gearbox which are used in conjunction with each other, with a transmission ratio of 60:1 to 106:1.

Further, there are two planetary reduction gearboxes, including a first planetary reduction gearbox and a second planetary reduction gearbox, one end of the first planetary reduction gearbox is connected to the power end assembly, the other end of the first planetary reduction gearbox is connected to the parallel reduction gearbox, and the other end of the parallel reduction gearbox is connected to the second planetary reduction gearbox.

Further, the planetary reduction gearbox includes one sun gear, four planetary gears and one gear ring, the four planetary gears form a planetary gear mechanism, the sun gear is located at the center of the planetary gear mechanism, the planetary gears and the adjacent sun gear and gear ring are in a normally engaged state; the parallel reduction gearbox includes a pinion and a bull gear, the pinion is coaxial with the sun gear of the first planetary reduction gearbox, and the bull gear is coaxial with the sun gear of the second planetary reduction gearbox.

Further, the other end of the power end assembly is connected to the reduction gearbox assembly through a spline or a flexible coupling.

Further, an input angle of the reduction gearbox assembly can be adjusted according to input requirements.

Further, the power end assembly includes a crankcase, a crosshead case and a spacer frame, one end of the crosshead case is connected to the crankcase, the other end of the crosshead case is connected to the spacer frame, the hydraulic end assembly is disposed at one end of the spacer frame and is connected to the crankcase through bolts sequentially passing through the spacer frame and the crosshead case; the reduction gearbox assembly is connected to the crankcase through bolts, a crankshaft in the crankcase is forged from alloy steel and includes six axle journals and five bellcranks, one bellcrank is disposed between every two adjacent axle journals, and the distance between the center of rotation of the bellcrank and the center of rotation of the crankshaft is 120 to 160 mm.

Further, a crosshead mechanism is disposed in the crosshead case, a connecting rod mechanism is disposed in the crankcase and the crosshead case, one end of the connecting rod mechanism is connected to the crankshaft, and the other end of the connecting rod mechanism is connected to the crosshead mechanism; the connecting rod mechanism includes a connecting rod cap, a connecting rod bearing bush and a connecting rod body, the connecting rod cap is connected to the connecting rod body through bolts, the connecting rod bearing bush is located in a cylindrical space formed by the connecting rod cap being connected to the connecting rod body, each of two sides of the connecting rod bearing bush is provided with a flange structure with a large width-to-diameter ratio.

Compared with the prior art, the beneficial effects of the present invention are as follows: The transmission ratio of the reduction gearbox assembly is changed to elevate the maximum input speed (reaching 16000 rpm). The connection between the current turbine engine and the pump through two reduction gearboxes and one transmission shaft is improved so that the turbine engine can be directly connected to the reduction gearbox assembly on the pump, which not only meets the reduction requirements, but also simplifies the structure of the entire fracturing equipment, of which the length is shorten, the transportation is convenient, the investment cost is decreased, and the maintenance becomes easy. The distance between the center of rotation of the bellcrank and the center of rotation of the crankshaft is optimized so that the maximum power of the plunger pump is increased to the current 5000-7000 hp. Each of two sides of the connecting rod bearing bush is provided with a flange structure with a large width-to-diameter ratio to enable a higher bearing capacity and a good locating effect. The input angle of the reduction gearbox can be adjusted according to input requirements to meet multi-angle adjustment and adapt to various installation requirements.

The present invention will be described in detail below with reference to the accompanying drawings and specific implementations.

### BRIEF DESCRIPTION OF THE DRAWINGS

FIG. 1 is a schematic structural diagram of a five cylinder plunger pump.

FIG. 2 is a schematic structural diagram of a reduction gearbox assembly.

FIG. 3 is a schematic structural diagram of a power end assembly.

FIG. 4 is a sectional view of a five cylinder plunger pump.

FIG. 5 is a sectional view along the directions of B-B and D-D (the planetary reduction gearbox) in the schematic structural diagram of the reduction gearbox assembly.

FIG. 6 is a sectional view along the direction of C-C (the parallel reduction gearbox) in the schematic structural diagram of the reduction gearbox assembly.

FIG. 7 is a schematic structural diagram showing the connection between the connecting rod mechanism and the crosshead mechanism.

FIG. 8 is a schematic structural diagram of a crankshaft.

Wherein, 1. power end assembly, 2. hydraulic end assembly, 3. reduction gearbox assembly, 4. crankcase, 5. crosshead case, 6. spacer frame, 7. crankshaft, 8. axle journal, 9. bellcrank, 10. cylindrical roller shaft, 11. valve housing, 12. plunger, 13. bearing seat, 14. front end plate, 15. cover plate, 16. supporting leg, 17. slide rail, 18. pull rod screw, 19. connecting rod cap, 20. a connecting rod bearing bush, 21. connecting rod body, 22. crosshead, 23. crosshead gland, 24. crosshead connecting screw, 25. crosshead guide plate, 26. guide plate bolt, 27. pull rod, 28. clamp, 29. first planetary reduction gearbox, 30. parallel reduction gearbox, 31. second planetary reduction gearbox, 32. bull gear, 33. pinion, 34. planetary gear, 35. gear ring, and 36. sun gear.

### DESCRIPTION OF THE EMBODIMENTS

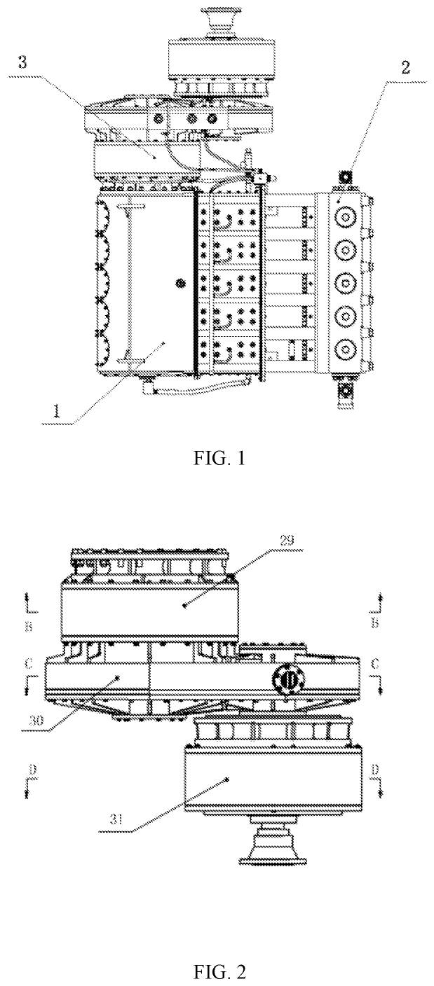

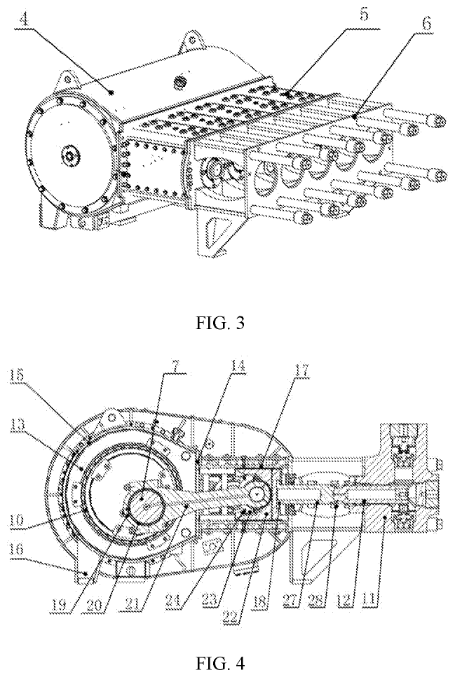

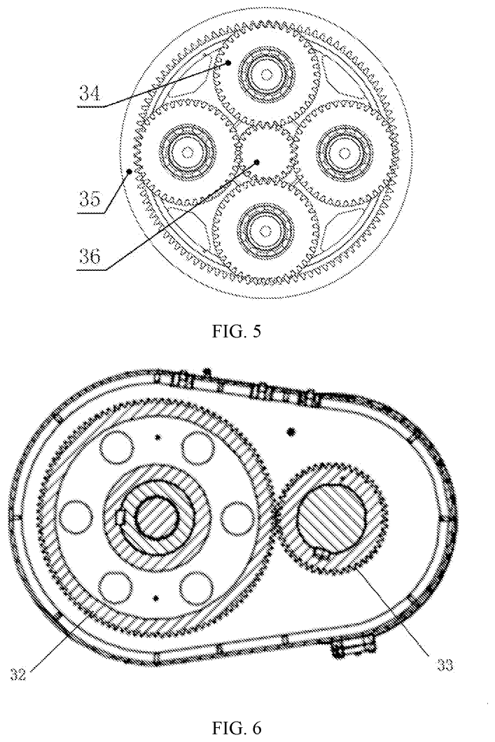

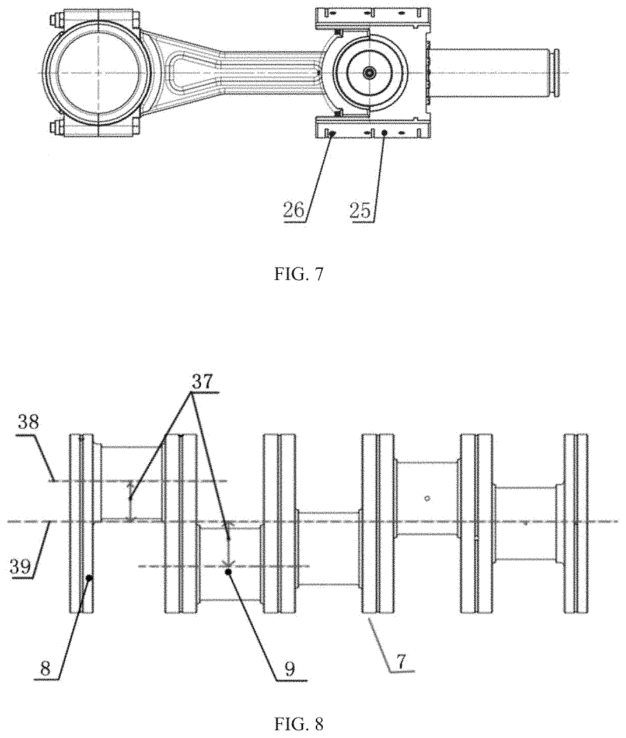

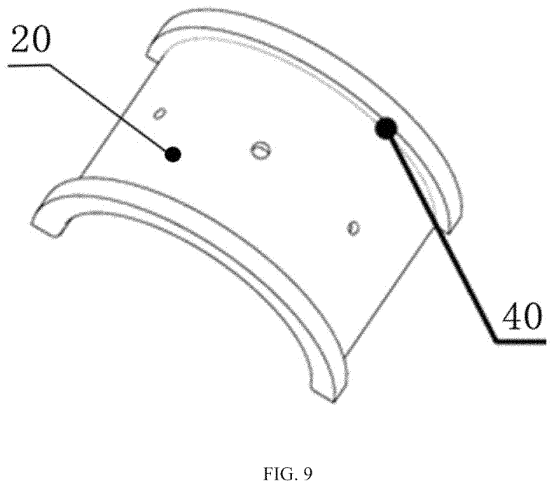

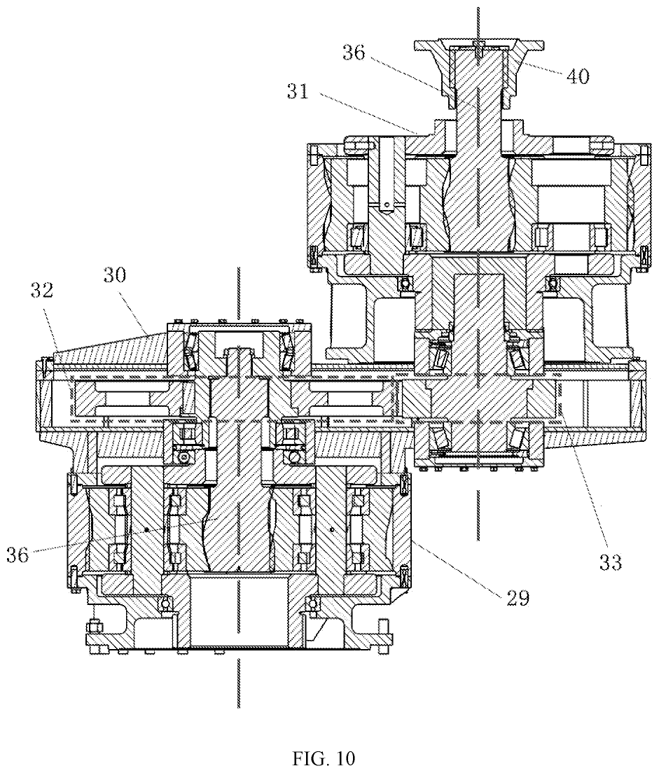

As shown in FIGS. 1 to 8, a five cylinder plunger pump, including a power end assembly 1, a hydraulic end assembly 2 and a reduction gearbox assembly 3, one end of the power end assembly 1 is connected to the hydraulic end assembly 2, the other end of the power end assembly 1 is connected to the reduction gearbox assembly 3; the reduction gearbox assembly 3 includes a planetary reduction gearbox 29 and a parallel reduction gearbox 30 which are used in conjunction with each other, with a transmission ratio of 60:1 to 106:1. The transmission ratio of the reduction gearbox assembly 3 is changed to elevate the maximum input speed (reaching 16000 rpm). The connection between the current turbine engine and the pump through two reduction gearboxes and one transmission shaft is improved so that the turbine engine can be directly connected to the reduction gearbox assembly 3 on the pump, which not only meets the reduction requirements, but also simplifies the structure of the entire fracturing equipment, of which the length is shorten, the transportation is convenient, the investment cost is decreased, and the maintenance becomes easy.

There are two planetary reduction gearboxes, including a first planetary reduction gearbox 29 and a second planetary reduction gearbox 31, one end of the first planetary reduction gearbox 29 is connected to the crankshaft 7 of the power end assembly, the other end of the first planetary reduction gearbox 29 is connected to the parallel reduction gearbox 30, the other end of the parallel reduction gearbox 30 is connected to the second planetary reduction gearbox 31, and the other end of the second planetary reduction gearbox 31 is connected to the transmission shaft of the turbine engine. In working, the kinetic energy transferred by the transmission shaft of a turbine engine is firstly reduced through the second planetary reduction gearbox 31, then secondly reduced through the parallel reduction gearbox 30, and finally reduced for the third time through the first planetary reduction gearbox 29.

The planetary reduction gearbox includes one sun gear 36, four planetary gears 34 and one gear ring 35, the four planetary gears 34 form a planetary gear mechanism, the sun gear 36 is located at the center of the planetary gear mechanism, the planetary gears 34 and the adjacent sun gear 36 and gear ring 35 are in a normally engaged state. The planetary reduction gearbox uses four uniformly distributed planetary gears 34 to transfer both motion and power at the same time. A centrifugal inertia force generated from the revolution of the four planetary gears 34 offsets the radial component of a counterforce between tooth contours, to reduce the force received by the main shaft and achieve high power transmission. The parallel reduction gearbox 30 includes a pinion 33 and a bull gear 32, the pinion 33 is coaxial with the sun gear 36 of the first planetary reduction gearbox 29, and the bull gear 32 is coaxial with the sun gear 36 of the second planetary reduction gearbox 31. Within the parallel reduction gearbox 30, reduction could be realized by transferring to the bull gear 32 through the pinion 33.

The other end of the power end assembly 1 is connected to the reduction gearbox assembly 3 through a spline or a flexible coupling.

The power end assembly 1 is designed as a segmented structure, so that the power end assembly 1 has a compact overall structure and can be processed and manufactured more easily, the assembly and maintenance of the entire pump become more convenient, and the processing costs are reduced at the same time. The power end assembly 1 includes a crankcase 4, a crosshead case 5 and a spacer frame 6, one end of the crosshead case 5 is connected to the crankcase 4, the other end of the crosshead case 5 is connected to the spacer frame 6; the hydraulic end assembly 2 is disposed at one end of the spacer frame 6 and is connected to the crankcase 4 through bolts sequentially passing through the spacer frame 6 and the crosshead case 5; the reduction gearbox assembly 3 is connected to the crankcase 4 through bolts, a crankshaft 7 in the crankcase 4 is forged from alloy steel and includes six axle journals 8 and five bellcranks 9, one bellcrank 9 is disposed between every two adjacent axle journals 8, that is a design of five cylinder structure. The design of five cylinder structure increases the output displacement of the plunger pump, and compared to a three cylinder pump, the five cylinder pump operates smoothly without vibration, thus reducing the vibration of the whole pump and prolonging its service life; and the distance between the center of rotation of the bellcrank 9 and the center of rotation of the crankshaft 7 is 120 to 160 mm. The distance between the center of rotation of the bellcrank 9 and the center of rotation of the crankshaft 7 is further investigated to increase the maximum power of the plunger pump to 5000-7000 hp, so that the plunger pump can output a higher pressure, i.e., provide a technical support for a long stroke, the stroke can reach 10-12 inches. A large displacement of the operation can be achieved, meanwhile the stroke number of the pump is reduced, thereby extending the service life of the components.

The hydraulic end assembly 2 includes a valve housing 11 and a plunger 12. The plunger 12 is disposed within the valve housing 11. The crankcase 4 is formed by welding steel plates, mainly by combining six bearing seats 13 and a front end plate 14, a cover plate 15, a supporting leg 16 and the like and welding them together, after then fine finishing the bearing seats 13 and the front end plate 14. The crosshead case 5 is formed by welding steel plates. An arc-shaped slide rail 17 is fixed on the crosshead case 5. The arc-shaped slide rail 17 is forged from alloy steel. The spacer frame 6 is provided with a support column with an arched structure, thereby improving the support strength. Each of the crosshead case 5 and the spacer frame 6 is provided with a through hole. The hydraulic end valve housing 11 is connected to the crankcase 4 through bolts sequentially passing through the spacer frame 6 and the crosshead case 5. The axle journals 8 are provided with a cylindrical roller shaft 10, the outer ring of which is equipped on the bearing seats 13.

A crosshead mechanism is disposed in the crosshead case 5, a connecting rod mechanism is disposed in the crankcase 4 and the crosshead case 5, one end of the connecting rod mechanism is connected to the crankshaft 7, and the other end of the connecting rod mechanism is connected to the crosshead mechanism; the connecting rod mechanism includes a connecting rod cap 19, a connecting rod bearing bush 20 and a connecting rod body 21, the connecting rod cap 19 is connected to the connecting rod body 21 through bolts, the connecting rod bearing bush 20 is located in a cylindrical space formed by the connecting rod cap 19 being connected to the connecting rod body 21, each of two sides of the connecting rod bearing bush 20 is provided with a flange structure with a large width-to-diameter ratio, enabling a higher bearing capacity and a good locating effect. The crosshead mechanism includes a crosshead 22, a crosshead gland 23, a crosshead connecting screw 24, a crosshead guide plate 25, and a guide plate bolt 26. The crosshead 22 and the crosshead gland 23 are forged from alloy steel. One end of the connecting rod mechanism is connected to the bellcrank 9, and the other end is connected to the crosshead 22 through the crosshead gland 23 and the crosshead connecting screw 24. The crosshead guide plate 25 is fixed on the crosshead 22 through the guide plate bolt 26. The crosshead guide plate 25 is arc-shaped and has an oil groove on the surface thereof. The crosshead 22 is connected to the plunger 12 of the hydraulic end assembly 2 through a pull rod 27 and a clamp 28. Further, the crosshead 22 is connected to the pull rod 27 through a pull rod screw 18.

An input angle of the reduction gearbox assembly 3 can be adjusted according to input requirements to meet multi-angle adjustment and adapt to various installation requirements.

The reduction gearbox assembly 3 drives the crankshaft 7 to rotate. The crankshaft 7 rotates in the bearing supported by the bearing seat 13. The crankshaft 7 drives the connecting rod body 21. The connecting rod body 21 drives the crosshead 22. The crosshead 22 reciprocally moves in the arc-shaped slide rail 17 of the crosshead case 5. The crosshead 22 drives, through the pull rod 27, the plunger 12 to reciprocally move in the valve housing 11 of the hydraulic end assembly 2 for the liquid suction and discharge.

It will be appreciated to persons skilled in the art that the present invention is not limited to the foregoing embodiments, which together with the context described in the specification are only used to illustrate the principle of the present invention. Various changes and improvements may be made to the present invention without departing from the spirit and scope of the present invention. All these changes and improvements shall fall within the protection scope of the present invention. The protection scope of the present invention is defined by the appended claims and equivalents thereof.

1. A quintuplex plunger pump, comprising a power end assembly, a hydraulic end assembly and a reduction gearbox assembly, one end of the power end assembly is connected to the hydraulic end assembly, the other end of the power end assembly is connected to the reduction gearbox assembly; the reduction gearbox assembly comprises two planetary reduction gearboxes and a parallel reduction gearbox which are used in conjunction with each other; wherein the reduction gearbox assembly has a transmission ratio of 60:1 to 106:1; and the quintuplex plunger pump is directly connected with the turbine engine; and
wherein the reduction assembly comprises a first planetary reduction gearbox and a second planetary reduction gearbox, one end of the first planetary reduction gearbox is connected to the power end assembly, the other end of the first planetary reduction gearbox is connected to the parallel reduction gearbox, and the other end of the parallel reduction gearbox is connected to the second planetary reduction gearbox.

2. (canceled)

3. The quintuplex plunger pump according to claim 1, wherein the two planetary reduction gearboxes each comprise one sun gear, four planetary gears and one gear ring, the four planetary gears form a planetary gear mechanism, the sun gear is located at the center of the planetary gear mechanism, the planetary gears and the adjacent sun gear and gear ring are in a normally engaged state; the parallel reduction gearbox comprises a pinion and a bull gear, the pinion is coaxial with the sun gear of the second planetary reduction gearbox, and the bull gear is coaxial with the sun gear of the first planetary reduction gearbox.

4. (canceled)

5. The quintuplex plunger pump according to claim 1, wherein the other end of the power end assembly is connected to the reduction gearbox assembly through a spline or a flexible coupling.

6. The quintuplex plunger pump according to claim 1, wherein the power end assembly comprises a crankcase, a crosshead case and a spacer frame, one end of the crosshead case is connected to the crankcase, the other end of the crosshead case is connected to the spacer frame, the hydraulic end assembly is disposed at one end of the spacer frame and is connected to the crankcase through bolts sequentially passing through the spacer frame and the crosshead case; the reduction gearbox assembly is connected to the crankcase through bolts, a crankshaft in the crankcase is forged from alloy steel and comprises six axle journals and five cranks, one crank is disposed between every two adjacent axle journals, each crank has an independent central axis, and the distance between the axial center of each crank and the axial center, which corresponds to the center of rotation, of the crankshaft is 120 to 160 mm.

7. The quintuplex plunger pump according to claim 6, wherein a crosshead mechanism is disposed in the crosshead case, a connecting rod mechanism is disposed in the crankcase and the crosshead case, one end of the connecting rod mechanism is connected to the crankshaft, and the other end of the connecting rod mechanism is connected to the crosshead mechanism; the connecting rod mechanism comprises a connecting rod cap, a connecting rod bearing bush and a connecting rod body, the connecting rod cap is connected to the connecting rod body through bolts, the connecting rod bearing bush is located in a cylindrical space formed by the connecting rod cap being connected to the connecting rod body, each of two sides of the connecting rod bearing bush is provided with a flange structure.
